(19) United States
(12) Patent Application Publication
(10) Pub. No.: US 2014/0047555 A1
(43) Pub. Date: Feb. 13, 2014

(54) METHOD AND SYSTEM FOR SECURING A SOFTWARE PROGRAM

(71) Applicant: Perrot Didier, Paris (FR)

(72) Inventor: Perrot Didier, Paris (FR)

(73) Assignee: IN-WEBO TECHNOLOGIES SAS, Paris (FR)

(21) Appl. No.: 14/111,691

(22) PCT Filed: Apr. 13, 2012
(86) PCT No.: PCT/FR12/00143

§ 371 Date: Oct. 14, 2013

(30) Foreign Application Priority Data
Apr. 14, 2011 (FR) 1153219

(51) Int. Cl. G06F 21/60

(52) U.S. Cl. CPC G06F 21/60
USPC 726/27

(57) ABSTRACT

The invention relates to a method for securing an original software program using a secret, comprising the following steps consisting in: partitioning (1) the software into N elements, N being an integer strictly greater than 1; generating (3) M secure procedures, M being an integer greater than or equal to N, by (i) randomly drawing one function from a library of functions, (ii) selecting one of the N elements or the empty set, and (iii) combining the randomly drawn function and the selected element when the selection is not the empty set, such that each element is combined in a single procedure and all of the elements are combined, each of these steps being performed for each procedure; modifying each procedure by introducing direction tags controlling procedure calls by one another, as well as tags controlling the execution of the elements; and concatenating (9) the M procedures in a secure software program in order to implement the secret.

### TECHNICAL FIELD

The present invention relates to a method, a system and a computer program product for providing security for an original piece of software implementing a secret.

### BACKGROUND

The development of online services, at the top of which services being the online payment services, makes it necessary to elaborate authentication and electronic signature systems that are reliable and can be implemented extremely economically on a very large scale.

One of the approaches for obtaining this objective is not technical but rather economical: it consists in distributing among “co-acceptors” the investments in proven security systems. By way of example, such systems are electronic certificates on a physical medium or single-use password generators including a hardware security element (“secure element”), although the latter do not allow electronic signature, are not immune to certain types of attack (phishing, man-in-the-middle), and, on account of their symmetrical nature, only require each co-acceptor to trust all the others (or a single, common one), that is to say requires the setup of a circle of trust. Beyond the organizational difficulty, this economical approach comes up against the difficulty of distributing the investments between co-acceptors; in the general case, this distribution does not occur and the authentication and electronic signature system continues to be a ‘private’ system that is fully financed by a single acceptor having the means to do so, and for its own needs.

An alternative approach is technical. This consists in elaborating security devices for authentication and electronic signature systems having a low or even zero marginal cost per user and for which there are, by design, no problems with distribution of the costs of equipment for the users.

Examples of systems having a low marginal cost per user are those in which the authentication and electronic signature means is an application (and/or data) stored on a medium that the user already has, such as a USB key, a mobile phone, a computer, a personal music player, etc., and executed directly on this medium or on a piece of equipment being connected thereto and having an application execution environment, such as a mobile phone or a computer. Such applications and data can indeed be produced and distributed at an almost zero marginal cost.

The major difficulty for this approach is the design of the security devices, since such applications and data are sensitive to many cases of attack. This is because the storage and execution media are particularly exposed to worms and malicious programs that are capable of taking control thereof or of reading the best-concealed information therein.

By way of example, the use of software certificates stored in internet browsers or on a storage medium that is not physically protected (disk or USB storage key, etc.) is inadvisable for authentication on banking or online payment services, since the private keys of such certificates can be imperceptibly stolen by a malicious program.

A second example is that of mechanisms that involve recognizing the storage or execution medium by virtue of its unique features (serial number, processor number, network card number, etc.): this is because the reading of these features requires the execution—generally local—of a program or a script that it is easy to modify and/or to bypass in order to allow impersonation.

A third example finally is that of applications for generating single-use passwords, whether these applications are executed on the terminal for accessing the service online or in another environment, and whether or not these applications are connected to the authentication server. This is because these applications implement a set of secrets, symmetrically or even asymmetrically (private key); access to this set of secrets, which are sometimes “hidden” but not protected by a hardware element, allows impersonation of the user; this can generally be implemented without particular expertise by virtue of means that are provided at low cost on the Internet network.

In these three examples representing the prior art, the access to the data, to the application or to the application and the data, respectively, is sufficient to bypass the security of the authentication and electronic signature system. These systems are generally protected by the input of an additional piece of information (“server PIN code”) by the user on the terminal on which the application is executed; however, this information is no more out of reach than the application and the data, on account of techniques known as “key logging” or “screen logging” (observation of keystrokes or mouse clicks on areas of the screen). Moreover, in the case of single-use password generation applications of conventional design, the observation of a single valid password is sufficient to reconstruct the value of the PIN code in the case of access to a storage medium for the data.

Thus, since the authentication and electronic signature systems have a marginal cost per user, they are generally vulnerable and cannot be implemented, for the “sensitive” services in which they are necessitated, without a security device of suitable design.

An example of such a security device is presented in the patent application FR2937204 in the name of the applicant: this is an authentication and electronic signature means executed on a piece of equipment other than the terminal for accessing the service, and moreover that is not connected—that is to say does not communicate with the server. This device does not hypothesize about the execution environment except that it is not accessible remotely, that is to say that the secrets implemented can be read therein only by having physical access to its medium. By way of example, an application that is executed in a virtual machine on a ‘single-task’ environment in a mobile phone verifies these hypotheses satisfactorily, but this is no longer the case from the moment at which an ‘open’ or ‘multitasker’ platform such as that of a computer or a “smartphone” is involved, and even less so when this platform is itself the terminal for accessing the services.

It would thus be particularly advantageous to have security devices that extend or complement those mentioned above, allowing the reliable use of authentication and electronic signature systems that can be implemented extremely economically on a large scale.

### BRIEF SUMMARY

In order to overcome one or more of the drawbacks or inadequacies cited above, a method for providing security for an original piece of software implementing a secret comprises:
partitioning of the software into N elements, N being an integer strictly greater than 1;
generation of M secure procedures, M being an integer greater than or equal to N, by, for each procedure:
   random drawing of a function from a library of functions;
   selection of one of the N elements or of the empty set;
   combination of the randomly drawn function and the selected element when the selection is not the empty set;
such that each element is combined in a single procedure and that all the elements are combined;
modification of each procedure by introduction of direction tags controlling the calls to the procedures by one another and of tags controlling the execution of the elements;
   concatenation of the M procedures into a secure piece of software capable of being installed and executed on an insecure execution platform for implementing the secret.

Features or particular embodiments, which can be used on their own or in combination, are as follows:
the direction tags controlling the calls to the procedures by one another have:
for each procedure, a selection of a plurality of procedures that can be called as a function of an execution parameter;
unpredictable conditions that are functions of execution parameters, fixing the execution of some of the selected procedures;
a mathematical series defined by a first term and a recurrence function defining a call argument for each procedure as if a procedure has the element from the series indexed n as a call argument, so the procedures called by said series have the element from the series indexed n+1 as a call argument;
the mathematical series is the Syracuse series;
the selection of the two callable procedures is based on a uniform function for the execution parameter ensuring that the call probability for each procedure is substantially identical;
the tags controlling the execution of the elements have calls to elements that are outside the element containing the call and, in the outside elements, destination indicators for these calls;
the functions from the function library are transformation functions modifying the value of at least one variable;
the original piece of software being a piece of software implementing a cryptographical method requiring at least one secret, the secret is provided by the variable modified by the transformation functions associated with the procedures;
the secret being partly calculated and partly dependent on an uncalculated secret for which the location is dynamic and calculated, the transformation functions modify a second variable when they are executed, the second variable being a pointer to the dynamic location;
the transformation functions modify a third variable when they are executed, the third variable being used by the software in order to encrypt and decrypt at least one of the elements;
the first term in the series is calculated from a random number used for the generation of a single-use password.

In a second aspect of the invention, a computer program product comprises program code instructions for executing the above method when the program is executed on a computer.

In a third aspect of the invention, a system for providing security for an original piece of software implementing a secret comprises a computer that is suitable for executing the method described above.

### BRIEF DESCRIPTION OF THE DRAWINGS

The invention will be better understood upon reading the description that follows, given solely by way of example, and with reference to the appended figures, in which:

FIG. 1 is a flowchart for a method according to an embodiment of the invention; and

FIG. 2 is a flowchart for a particular step in the method from FIG. 1.

### DETAILED DESCRIPTION

First of all, a method P allowing a code CF* to be derived from the code CF is described. The method P allows the obtainment of a unique code CF* for each user and environment EE, or for a reduced subset of users, such that by observing the codes CF* that a significant number of users have, the probability of two of these codes being identical or similar is zero or very low.

The method P can be implemented by numerous devices (“development tools”), which are preferably suitable for conferring high automation capability on the method P.

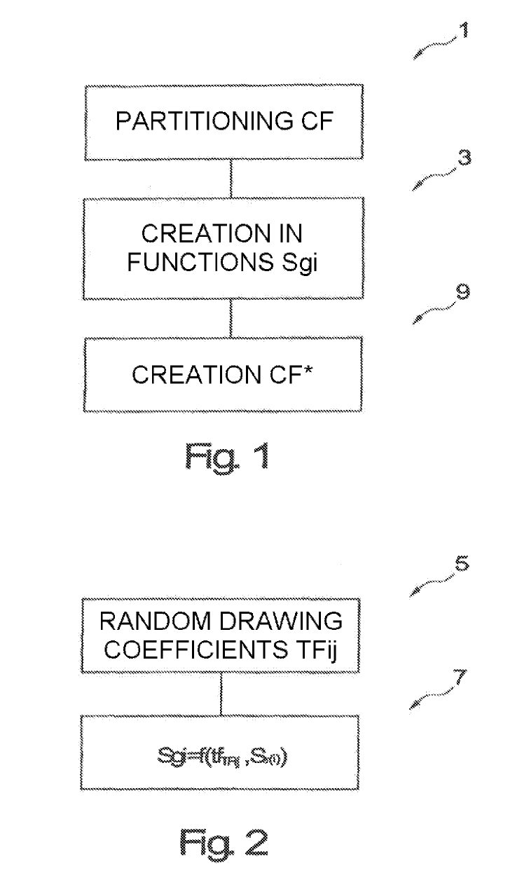

The first step in the method P involves, step 1 in FIG. 1, defining a random and more or less arbitrary partition for the code CF into segments S1, S2, . . . , SN, where N is an integer strictly greater than 1 that is drawn randomly. This partition can be made on the source code for CF or else on the executable code by observing a few rules that will be explained in detail in the rest of this document.

The second step 3 in the method P involves creating the source code for M procedures SYi, M being an integer greater than or equal to N.

This is accomplished by performing, step 5 in FIG. 2, the random drawing of a matrix TF of positive or zero integer coefficients TFᵢⱼ, said matrix having as many rows as there are functions Sy. The coefficients TFij of TF refer to a library L of functions tf, that is to say that for a given index i the coefficients TFij use their value to denote the functions that will be used in SYi from the library L. Zero indicates the absence of a function. 1\ is suitable for denoting that the library L preferentially contains a number of functions that is much greater than there are functions Sy. The nature and role of these functions tf will be described below after the end of the description of the method P.

The code of SYi is thus put together, step 7, by combining the code of the procedures tf denoted by the coefficients TFij and that of the segment Sa(i), where a is a permutation of the indices that is drawn randomly.

The third and last step 9, with reference to FIG. 1, of the method P involves finalizing the code CF* by introducing into the code of the functions Sy firstly “switching” conditions, that is to say controlling the recursive calls to the functions Sy by one another, and secondly tags controlling the execution of the segments Sj.

The recursive calls, first of all, are defined and controlled by three types of parameters:
two index permutations, aine and aeond, drawn randomly and defining, upon execution, what functions SYaine(i,x) and SYaeond(i,x) are called by SYi, where x represents parameters of the execution; as functions of x (fine and aeond are preferentially uniformly distributed, that is to say that the call probability is the same for each function Sy;
a condition Ci(X) that is drawn randomly, is a function of parameters of the execution x and defines, upon execution, whether SYaeOnd(i,x) is effectively called by SYi (conditional call), while the call to SYaine(i,x) is unconditional;
a mathematical series (Un) defined by its first term Ua and its recurrence relation f defining Uₙ₊₁ as f(Uₙ), used in the following manner: if SYi has been called with Un as argument, SYaine(i,x) and SYaeond(i,x) are called with f(Uₙ), that is to say Uₙ₊₁ as argument.

The tags, next, allow control of the execution of the segment Sa(i) in the function SYi. This is because the execution order for the SYis is unpredictable when the method P is implemented, firstly because this order depends on execution parameters and conditions and secondly because it depends largely on the random drawing of U₀ that occurs upon each new execution. It can thus easily be understood that it is necessary to control the execution of the segments of CF so that, in terms of functionalities, CF is included in CF*, that is to say that the execution of CF* provides at least the authentication or the electronic signature and/or the other functionalities that are the subject of CF.

In the particular case in which the code CF can be executed by executing each segment Si sequentially, fully at a single time, the role of the tags simply involves organizing these executions, that is to say seeing to it that Si is executed a single time, after and before Sᵢ₊₁. In this case, upon each execution of SYi, its suffices to verify whether the conditions prior to the execution of Sₐ₍ᵢ₎ are verified, that is to say whether Sa₍ᵢ₎₋₁ has already been executed and whether Sₐ₍ᵢ₎ has not yet been. This verification occurs preferentially by fixing the value of a tag after execution of Sa₍ᵢ₎₋₁ to a value that serves as a condition for entry to the execution of Sₐ₍ᵢ₎.

In the more general case in which the execution of the code CF requires one or more instances of execution of the segments Si, possibly partially and in a manner determined to some extent by the conditions of execution themselves, the control tags are generalized in order to allow multiple execution, partial execution and/or execution starting in the course of a segment. In the same way as previously, the value of a tag is fixed at the end of a segment Si or at the point of a call to a segment outside Si; this tag defines both what segment Sj needs to be executed and the point at which execution starts, that is to say the start of the segment Sj or the destination of the call. These tags are thus a representation of the structure of the calls between various areas of CF and not just of the partition of CF. The insertion of the control tags requires additional adaptation of the device implementing the method P.

It should be noted that a large element in the implementation of the method P for the generation of the code CF* is guaranteeing that the code CF is fully executed when CF* is executed. The definition of what classes of codes CF are executed fully, that is to say have a start and an end, is an open problem. The question regarding the sole execution of CF “immersed in CF*” will thus not be pondered unless it is supposed that the code CF itself is executed fully when it is executed autonomously; furthermore, we note that if the application is restricted to operations allowing the calculation of an authentication code or an electronic signature then the resulting code CF indeed has a start and an end at a finite time subject to input of the PIN code by the user.

The issue for such a code, once partitioned into N segments Si, is to know whether all of these segments or fractions of segments will be executed a sufficient number of times, when it is impossible to predict deterministically the execution of the functions Sy containing these segments. For that purpose, it is sufficient for the number of recursive calls to the functions Sy among one another to be sufficiently large and for all the functions Sy to have the same probability of being called.

The second satisfactory condition has been imposed in the definition of aine and Ocond. The first satisfactory condition is assessed notably according to the choice of your series (Un) and of its first term Ua.

Many variants exist, for example choosing for (Un) the Syracuse series defined by the following recurrence relation:

Uₙ₊₁ is equivalent to Un!2 if Un is even

Uₙ₊₁ is equivalent to 3Uₙ+1 if Un is odd and different than 1

Uₙ₊₁ is equivalent to 1 if Un is equivalent to 1.

The special feature of this series is that there is a conjecture according to which it converges in a finite number of steps toward 1 whatever the first term. This allows a simple stop condition for the code CF*: it is sufficient to stop new recursive calls—thus to start to “reassemble” the stack used for the recursive calls—as soon as Un has reached the value 1.

Moreover, estimations of the number X of steps that are necessary according to Ua for the convergence of this series are available.

If a is the probability—supposed uniform—that the condition Ci is verified and if X denotes the number of steps required for the convergence of the chosen series (Un)—if it converges, the number of recursive calls to functions Sy is in the order of “1+E)X−₁)h:. A “self-adaptive” means of responding to the issue regarding the full execution of CF* is thus to fix the order of magnitude of Ua such that X is larger (preferentially at least several orders of ten) and to decrease E as the segments Si are executed.

Thus, the number of calls to functions Sy that remain potentially to be executed is gigantic (−r) as long as no segment Si has been executed, whereas it decreases rapidly as the segments are executed and it becomes lower than X when all the segments have been executed, the total number of calls being in the order of N.X. This empirical method works for classes of codes CF in which there is a priori knowledge of a good approximation of the number of segments needing to be executed. When this is not the case, the condition for stopping the recursive calls is preferentially completed with a tag controlling the end of the execution of CF.

Finally, to complete the implementation of the method P, a function Sy that is initially called is chosen.

The method P described previously thus allows a code CF* to be obtained that is functionally at least equivalent to CF, CF* being derived from CF by the random drawing of a restricted number of parameters, principally N, TF, aine, aeond, Ci, and the tags for controlling execution of the segments S1, . . . SN. The combinatorics inherent to these parameters makes it possible to guarantee, when this is necessary within the framework of an implementation of this invention, that the code CF* is derived almost uniquely from CF.

The functions tf dealt with in the description of the method P are functions referred to as translation functions. Their role is to modify the value of a variable called RTK standing for “Run-Time Key”. The modification made to RTK by a function tf is arbitrary and can depend on execution parameters x; by way of example, it may be an algebraic operation relating to the current value of RTK, of x and of other constant parameters, an operation on the binary representations (rotations, transpositions, permutations), a logic operation (AND, OR, exclusive OR, complement), compounds of such operations, etc. The library L contains a preferentially large set of such functions tf, implemented in CF* by the method P when they are denoted by the coefficients of the randomly drawn matrix TF.

The value of RTK results from the set of the modifications made by the functions tf, and therefore not only from the value of the execution parameters implemented by the functions tf, but especially from what functions tf have been executed. In turn, the functions tf executed and the sequence according to which they are executed are dependent on what functions Sy have been called recursively (notably linked to Uo, aine, Oeond, X), and on the result of the conditions Ci.

Thus, a first feature permitted by the code CF* derived from CF by virtue of the method P is that it implements an implicit and unique calculation for a variable RTK. Unique because of the combinatorics implemented by the method P; implicit because it is impossible to describe the formula that allows the calculation of RTK otherwise than in a form equivalent to the code CF*, notably because this formula has a non-algebraic dependency on the value of Uₒ for a series (Un) chosen in a suitable manner.

A second important feature is that in order to produce the calculation of RTK in a manner identical to the code CF* of a given user, it is sufficient to know the parameters (N, TF, aine, Oeond, Ci, tags) drawn randomly during the implementation of the method P that has generated CF*. This means that the server that has to check the validity of the authentication codes and of the electronic signatures from multiple users can produce the calculation of RTK for each of these users by executing a unique and identical code CF* for all of the users, into which it inserts the parameters (N, TF, aine, Oeond, Ci, tags) inherent to each user during the execution. By contrast, these parameters are not explicitly defined in the code CF*.

From these features are deduced a device for providing security for the authentication and electronic signature application: the application is suitable for using the value of RTK for the calculation of the signatures with which the authentication server is provided in addition to the secrets (stored data, input PIN code) already used in this calculation. Whether this calculation implements a symmetrical or asymmetrical method, the server that has performed a similar calculation of RTK is thus able to verify the validity of the signatures.

To do this, the application is adapted in the following manner:

The code CF has “check points” introduced into it where some of the execution parameters x are updated; the role of these check points is to help to protect the execution of certain parts of the code CF, the principle being that if this part of the code was bypassed or modified, the check point would probably also have been and the value of RTK calculated by the code CF* of the user and that calculated by the server would thus differ. An example of a part of the code CF that it is useful to protect is that ensuring that the secret information input by the user (PIN code) is actually input—that is to say corresponds to events linked to the hardware, keyboard or mouse—and not provided by an automatic script.

The provision of security for the authentication and electronic signature application provided by the derivation of CF* from CF by the method P can be presented in the following manner.

An attack made by a malicious program accessing secrets (data stored and input by the user) does not work. This is because the success of the authentication or the validity of the electronic signature requires access to a key RTK calculated by the application. This key cannot simply be stolen either because it is never stored and is valid only for the execution in the course of the application.

An attack made by a malicious program accessing secrets (notably the data input by the user) and triggering the execution of the application as a background task or in the probable absence of the user, then inputting information expected from the user in his place, does not work. This is because the application verifies that this information is actually provided by a user.

An attack made by a malicious program accessing secrets (data stored and input by the user) and attempting to analyze the way in which the key RTK is calculated in order to calculate it without executing the application does not work. This is because the code of CF* performing the calculation of RTK cannot be extracted automatically by a program: this code is actually variable in size (number of functions Sy), in structure (presence or absence of functions tf, as a variable number), and in composition (the library L containing many more functions tf than there are functions tf in a code CF* and being extensible ad libitum, it is not possible for a malicious program to know all of the functions tf, even by relying on manual and prior analysis of many codes CF*). Automatic analysis of CF* in order to extract therefrom the parameters that are known to the server and sufficient for calculating RTK is not possible automatically because it requires modeling of the code CF*, which requires reliance on known stable patterns, in terms of structure and content.

By contrast, this implementation of the invention does not cover the cases of attacks in which a malicious program relies on modeling of CF and not of CF*, nor the cases of attacks in which a malicious program exports the secrets and the code CF* for manual analysis purposes. These cases will be dealt with in the variant embodiments presented in the rest of this document because the adaptations required differ according to whether or not the application works in connected fashion.

The invention has been illustrated and described in detail in the drawings and the description above. This needs to be considered as illustrative and provided by way of example. Numerous variant embodiments are possible.

In a first variant embodiment of this invention that is valid for a connected authentication or electronic signature application, that is to say one that, during its execution, implements a bidirectional protocol with the server, the method P is suitable for the insertion of functions tf dedicated to the calculation of a variable RTS an of a variable RTM into the functions Sy. The code CF* thus allows the calculation of a variable RTS standing for “Run-Time Store” and of a variable RTM standing for “Run-Time Mask” in a manner similar to the calculation of the variable RTK.

The application is suitable for using the value of RTS (or RTM) for calculating the authentication code or the electronic signature. This means that some of the modifications to the value of RTS (or RTM) by the functions tf are made before the use of RTS (or RTM) by the application and that others are made afterwards.

If RTSₒ (or RTMo) is used to denote the value of RTS (or RTM) at the time at which it is used by the application, and RTS_{end} (or RTM_{end}) is used to denote the value when a point of reference for the code CF (for example the end of execution of CF) is crossed, the server is suitable for providing the application with a piece of information ÔRIS (or ÔRTM) before—and preferentially simultaneously with—the time at which RTS (or RTM) is used by the application, such that ÔRTS (or ÔRTM) is the difference between RTSₒ (or RTMo) and RTSend (or RTM_{end}) the value obtained for the preceding execution and stored by the server. In this case, “difference” is specifically understood to mean an injective binary operation. The provision of dRTS (or dRTM) by the server allows the application to determine the value of RTSend (or RTM_{end}) that is obtained for the preceding execution, this value being correct and corresponding to the value stored by the server only because the code CF* has effectively been able to calculate RTSₐ (or RTMa).

The server and the application are suitable for the value Ua preferentially being provided by the server and for the updates to the execution parameters x in the check points preferentially being produced by virtue of information provided by the server.

The server is moreover suitable for implementing a “point of no return”. Starting the calculation of an authentication code or an electronic signature allows this “point of no return” to be crossed, for example when the application asks the server for the value of Ua. Once this point is crossed, the code CF* has to terminate correctly and within a short period the authentication or the electronic signature using RTK, RTS and RTM, failing which the server irreversibly blocks use of the application.

Equally, the application and the server are suitable for the secrets being renewed after each successful authentication or electronic signature. In this case, “secrets” specifically denotes the data stored by the application rather than the information input by the user. The way of renewing the secrets on condition of success must preferentially not require the transfer of these secrets between the application and the server. If the secrets are implemented asymmetrically, a method of keysharing such as Oiffie-Hellmann is preferentially implemented. If the secrets are implemented symmetrically, the application and the server preferentially exchange an update key (OK) that is applied in identical fashion by the application and the server to the existing secrets in order to produce new ones therefrom according to the following operation:

secrets_{new}=H(secretsold*OK)

where H is a one-way function (preferentially a function derived from a hash function) and * is a binary operator.

The variable RTS is used by the code CF* in order to determine the dynamic storage location of the secrets used by the authentication and electronic signature application. The storage location of the secrets on the storage means MS is determined by virtue of the value of RTS_{end}. The value of RTS_{end} obtained for the preceding execution denotes the current location of the secrets, and the value obtained for the current execution denotes the location of the renewed secrets. In the same way as for the renewing of the secrets, the storage location of the secrets is updated only if the authentication or the electronic signature is successful.

An important feature of the method P that is suitable for the code CF* calculating RTS is that the location of the secrets used for the authentication or the electronic signature cannot thus be known without executing the application.

It is important to note firstly that the value of the information input by the user (PIN) does not intervene in the calculation of the variables RTK, RTS or RTM by the code CF*, and thus does not bring about blockage of the use of the application on account of a typing error; secondly that if the user aborts, the application is capable of terminating the calculation of RTK, RTS and RTM and of communicating with the server relying on these calculations, thus not leading to blockage in the case of abortion or premature closure of the application.

It is easily conceivable that the method allowing determination of the location of the secrets from the value of RTS must be discrete so as not to be simply bypassed, and that the space for what is possible must likewise be sufficiently vast for it not to be possible to be certain that the secrets are definitely located in a limited area of the storage means MS or in one or more given files indexed by the file management system of the means MS.

A first example of such a method is creation of one or more files in trees linked to the operating system of the medium for executing the application that is supposed to be of sufficient vastness. Another example that is even more discrete is not to store secrets but to use the values stored in arbitrary locations on the storage means as secrets; the update of secrets between the application and the server thus involves the application indicating to the server the value of the locations denoted by the value of RTS. The method of authentication on the basis of these secrets is suitable, since it is not possible to guarantee by means of such a method that the values contained in the locations will not be modified by other tasks or applications accessing the storage means MS. The authentication is thus performed not on the basis of certainty (equality of the secrets) but rather on the basis of a probability (degree of similarity of the secrets).

Finally, the variable RTM is used by the application to encrypt and decrypt the executable code of some segments Si in which a check point has been inserted.

The adaptations to this variant embodiment make it possible to counter several additional types of attacks.

Thus, the attack made by a malicious program exporting the secrets (notably, the information input by the user) and the code CF* of the application for manual analysis and expertise purposes cannot succeed. The reason is that this malicious program that has not been able to execute the code CF* before exporting it for the reasons recalled in the description of the first implementation of the invention cannot know the value of RTS either, and therefore cannot export some of the necessary secrets. The attacker recovering the code CF* can analyze and execute it but, in order to do so, it is obliged to cross the “point of no return”. If he manages to calculate RTS and therefore to determine the location of the secrets on the storage means MS of the user, he does not have the value of said secrets and has only a low probability of obtaining them within the time limits, since the server demands a response from the application just after having provided it with the value of 8 RTS. This results in the application being blocked. It continues to be possible for the application to be unblocked by the user storing other proofs of his identity with the online service implementing the authentication system, but this is done only after a new code CF* has been distributed to the user. The attacker thus loses any benefit from the attack that he has undertaken.

Moreover, an attack made by a malicious program relying on the manual reconstruction and analysis of the code CF (invariant) from one or more codes CF* in order to modify certain segments Si in CF* cannot succeed. The reason is that the sensitive elements are encrypted by the value of RTM and contain a check point. Since the value of RTM is not known unless the code CF* is executed and a “point of no return” is crossed, the malicious program can neither selectively deactivate these sensitive elements nor bypass them since they contain check points. An example of a sensitive element is the portion of the code CF that checks that the input of a piece of information by the user is indeed accompanied by events linked to hardware (keystroke, mouse click, etc.).

In a variant embodiment of the variant presented above, the application is suitable for preventing the automatic execution of the application by virtue of a Turing test, for example, implementation of a “captcha” that the user has to input, or of a secret that is known to the user, displayed in graphical form, in a manner that is always different and not easily recognizable by a program, that the user has to recognize among other character strings instead of the use of a mask RTM.

In a second variant embodiment that is valid for an unconnected authentication or electronic signature application, that is to say one that implements a unidirectional protocol, made up of a single message, with the server when it is executed, the method P is suitable for functions tf dedicated to the calculation of a variable RTS and of a variable RTM being inserted into the functions Sy. The code CF* thus allows the calculation of a variable RTS standing for “Run-Time Store” and of a variable RTM standing for “Run-Time Mask” in a manner similar to the calculation of the variable RTK.

The application is suitable for use of the value of RTS (or RTM) for calculating the authentication code or the electronic signature. This means that some of the modifications to the value of RTS (or RTM) by the functions tf by made before the use of RTS (or RTM) by the application and that others are made afterwards.

The method P generating the code CF* is suitable as follows: owing to the control tags, no segment Si is executed before a parameterizable number (Y) of recursive calls to the functions Sy. Moreover, the functions Sy can be called according to two modes “get” (search) and “set” (definition) by virtue of the value of a parameter. In “get” mode, the recursive call to the functions Sy stops after the paramterizable number Y of calls. RTS₁ (or RTM₁) are used to denote the value taken by the variable RTS (or RTM) at that time, and this value is stored by the application.

During execution of the application and of the code CF* that are suitable, the functions Sy are called a first time in “get” mode with the value of Uo from the preceding execution stored by the application, then a second time in “set” mode with the value of Uₒ from the current execution.

The value of RTS₁ (or RTM₁) that is obtained for the first call is used to determine the storage location of the secrets that is implemented for the authentication or the electronic signature (or for decrypting one or more sensitive areas). The value of RTS₁ (or RTM₁) that is obtained for the second call is used to determine the location at which the secrets will be stored after they have been used (or for re-encrypting one or more sensitive areas after they have been executed).

Since the application is unconnected, it is suitable for randomly drawing the value of Uo. The server, for its part, is suitable for the use of this value and for checking that it is not re-submitted. A preferential way of performing these adaptations when the authentication application is the one described in the patent application FR2937204 is to deduce, in a simple and deterministic manner, the value of Uo from that of the key Rand drawn randomly during the generation of a single-use password. However, the key Rand is made available to the server because it is sufficiently short to be loaded into the authentication code or the generated electronic signature, and there is a check to ensure that it is not re-submitted; the transmission of Uₒ to the server and the absence of re-submission thereof are thus ensured by means of those of Rand.

Equally, the application and the servers are suitable for the modifications to the parameters of the execution that are used in the check points being made by the application and similarly by the server without communication between the application and the server.

The adaptations of this variant embodiment allow several additional types of attack to be countered.

Thus, the attack made by a malicious program exporting the secrets (notably the information input by the user) and the code CF* of the application for manual analysis and expertise purposes cannot succeed directly. Let us already note firstly that such an attack is neither automatic nor industrial for the reasons already presented, and secondly that the export of the code CF* requires the application to be stored and executed in an environment that is connected even though the application is unconnected. Since the malicious program has not been able to execute the code CF* before exporting it for the reasons recalled in the description, it is not able to know the value of RTS either, and therefore can export only some of the secrets. The attacker recovering the code CF* can analyze and execute it; in order to calculate a correct value for RTS, he needs to have the value of Ua during the preceding execution and to make the attack—following manual analysis of the code CF*—before the code CF* is executed by the user again, because this would bring about modification of the value of RTS. With knowledge of RTS, he is thus able to attempt to obtain the values of the secrets stored at the locations denoted by RTS on the storage means MS of the user, which requires firstly that the means MS is connected and secondly that the malicious program takes the initiative to set up an outgoing connection. Only then, and in the case of the application described in the patent application FR2937204 only if the user has not implemented the authentication means, could the attack succeed. Finally, it should be noted that the installation of a malicious program and its capability to set up outgoing connections discretely are greatly limited in execution environments such as mobile phones.

Moreover, an attack made by a malicious program relying on the manual reconstruction and analysis of the code CF (invariant) from one or more codes CF* in order to modify certain segments Si in CF* cannot succeed directly. The reason is that the sensitive elements are encrypted by the value of RTM and contain a check point. Since the value of RTM is not known unless the code CF* is executed, the malicious program can neither selectively deactivate these sensitive elements nor bypass them since they contain check points. By contrast, it can theoretically
modify an unprotected portion of the code CF* in order to render the execution of the code CF* relatively discrete and to calculate the value of RTM, and then, on this basis, decrypt the protected areas, modify them and finally execute the complete code CF*. Since the application is not connected, the malicious program would thus have to set up an outgoing connection in order to provide an attacker with an authentication code or a valid electronic signature that is calculated by this attack. Finally, in the case of the application described in the patent application FR2937204, this authentication code would have to be used by the attacker within a very reduced time limit (typically less than one minute after calculation thereof) and before the user has generated another. It should likewise be noted that the installation of a malicious program and its capability to execute itself and to set up an outgoing connection without the knowledge of the user are greatly limited in execution environments such as mobile phones.

In the claims, the word “comprising” does not exclude other elements and the indefinite article “a/an” does not exclude a plurality.

1. A method for providing security for an original software implementing a secret, said method comprising:
partitioning of the software into N elements, N being an integer strictly greater than 1;
generation of M secure procedures, M being an integer greater than or equal to N, by, for each procedure:
random drawing of a function from a library of functions;
selection of one of the N elements or of the empty set;
combination of the randomly drawn function and the selected element when the selection is not the empty set;
such that each element is combined in a single procedure and that all the elements are combined;
modification of each procedure by introduction of direction tags controlling the calls to the procedures by one another and of tags controlling the execution of the elements;
concatenation of the M procedures into a secure software capable of being installed and executed on an insecure execution platform for implementing the secret.

2. The method as claimed in claim 1, wherein the direction tags controlling the calls to the procedures by one another have:
for each procedure, a selection of a plurality of procedures that can be called as a function of an execution parameter;
unpredictable conditions that are functions of execution parameters, fixing the execution of some of the selected procedures;
a mathematical series defined by a first term and a recurrence function defining a call argument for each procedure as if a procedure has the element from the series indexed n as a call argument, so the procedures called by said series have the element from the series indexed n+1 as a call argument.

3. The method as claimed in claim 2, wherein the mathematical series is the Syracuse series.

4. The method as claimed in claim 2, wherein the selection of the two callable procedures is based on a uniform function of the execution parameter ensuring that the call probability for each procedure is substantially identical.

5. The method as claimed in claim 2, wherein the tags controlling the execution of the elements comprise calls to elements that are outside the element containing the call and, in the outside elements, destination indicators for these calls.

6. The method as claimed in claim 1, wherein the functions from the function library are transformation functions modifying the value of at least one variable.

7. The method as claimed in claim 6, wherein, the original piece of software being a piece of software implementing a cryptographical method requiring at least one secret, the secret is provided by the variable modified by the transformation functions associated with the procedures.

8. The method as claimed in claim 7, wherein, the secret being partly calculated and partly dependent on an uncalculated secret for which the location is dynamic and calculated, the transformation functions modify a second variable when they are executed, the second variable being a pointer to the dynamic location.

9. The method as claimed in claim 8, wherein the transformation functions modify a third variable when they are executed, the third variable being used by the software in order to encrypt and decrypt at least one of the elements.

10. The method as claimed in claim 2, wherein the first term in the series is calculated from a random number used for the generation of a single-use password.

11. A computer program product comprising program code instructions for the execution of the method as claimed in claim 1 when said program is executed on a computer.

12. A system for providing security for an original piece of software implementing a secret, said system comprising a computer that is suitable for executing the method as claimed in claim 1.
